(19) United States
(12) Patent Application Publication
(10) Pub. No.: US 2019/0102846 A1
(43) Pub. Date: Apr. 4, 2019

(54) Systems and Methods For Increasing Lead Conversion Rates For Prospective Buyers and Sellers Of Real Estate

(71) Applicant: Boldleads.com, Inc., Chandler, AZ (US)

(72) Inventor: Daniel Loschiavo, Tempe, AZ (US)

(21) Appl. No.: 15/724,757

(22) Filed: Oct. 4, 2017

(51) Int. Cl. G06Q 50/16; G06Q 10/06; G06Q 30/00

(52) U.S. Cl. CPC G06Q 50/16; G06Q 30/0201; G06Q 30/01; G06Q 10/06316

(57) ABSTRACT

Systems and methods for managing a call list of leads for a real estate agent. The method includes maintaining respective logs of text and email messages for a plurality of leads; adjusting a respective engagement score for each lead based on that lead's email and text log; and adjusting the relative position of each lead in the call list based on the relative value of each lead's engagement score.

### FIELD OF THE INVENTION

The present invention relates, generally, to automated techniques for harvesting and converting buyer and seller leads for real estate agents and, more particularly, to computer implemented techniques for algorithmically monitoring and nurturing lead engagement.

### BACKGROUND

Mature and powerful desktop applications have been proposed for managing real estate agents' and brokers' daily activities. For example, the LionDesk™ system available from LionDesk, LLC, of Carlsbad, Calif. offers an integrated solution for managing drip campaigns, auto-responders, tasks and calendaring, email tracking and marketing, customer relationship management (CRM), transaction management, click-to-call, lead importing, document management, and lead sharing across teams.

Current buyer and seller lead generation and management systems, however, are limited in that they do not effectively monitor and prioritize leads and, hence, they tend to have low lead conversion rates.

Systems and methods are thus needed which overcome these limitations.

### BRIEF SUMMARY

To achieve the foregoing and other objectives, various embodiments of the present invention contemplate: i) strategically placing ads in social media (e.g., Facebook and Yahoo Gemini) news feeds targeting potential buyers and sellers while leveraging native ad placement services; ii) driving potential leads to a suite of landing pages which may be dynamically updated based on tracked conversion rates of landing pages; iii) presenting the leads to agents in the form of a call list; iv) applying messaging funnels to each lead; v) re-prioritizing the leads in the call list and updating the sequence and cadence of messages within the funnels based on individual and aggregate lead engagement scores; vi) providing real time alerts to agents when sellers are actively engaged in reviewing valuation reports and when buyers are actively engaged in reviewing listings; vii) calculating a lead engagement score based on tracking texts/emails that are opened by or replied to by a lead, and adjusting the priority of the lead within the call list based on the lead's engagement score; viii) adjusting the position of the emails/texts that are opened/replied to by the lead within the funnel template; and ix) comparing, for each agent account, current advertising expenditures against the number of placed ads and adjusting one or both metrics to reconcile expenditures with placed ads.

### BRIEF DESCRIPTION OF THE DRAWING FIGURES

The foregoing and other features, aspects, and advantages of the present invention will become better understood with reference to the following description, appended claims, and accompanying drawings, where:

FIG. 1 is a screen shot of an exemplary seller landing page in accordance with various embodiments;

FIG. 2 is a screen shot of an exemplary buyer landing page in accordance with various embodiments;

FIG. 3 is a screen shot of an exemplary landing page management tool in accordance with various embodiments;

FIG. 4 is a screen shot of an exemplary call list management tool in accordance with various embodiments;

FIG. 5 is a screen shot of an exemplary funnel management tool in accordance with various embodiments;

FIG. 6 is a schematic block diagram of a dynamically re-configurable messaging funnel in accordance with various embodiments; and

FIG. 7 is a schematic flow diagram of a method of using engagement scores to update call lists and messaging funnels in accordance with various embodiments.

### DETAILED DESCRIPTION OF PREFERRED EXEMPLARY EMBODIMENTS

Various embodiments of the present invention contemplate an enterprise level system for managing the interaction between a real estate professional and prospective leads, including both buyers and sellers. One embodiment provides a seller lead platform and a buyer lead platform, each having a configurable suite of landing pages and funnels. Seller leads are harvested from news feed ads targeted to homeowners which ask open ended questions such as “What's your home worth”, whereas buyer leads are harvested from feed ads which prompt the reader to “click here to see a list of [luxury, foreclosure, etc.] homes in your area”. Agents can purchase a license to use the seller package, the buyer package, or both.

By clicking on an ad, the potential buyer or seller is directed to a dedicated landing page designed to collect enough information (e.g., name, physical address, phone number, email address) to create a complete (or at least a partial) lead profile. The leads are then uploaded to a lead management tool which may also serve as a call list, as described in greater detail below.

The lead management tool may be configured to apply any one of a plurality of messaging funnels to each lead. Succinctly, a funnel comprises a series of predetermined (or customizable) messages—typically email, text, and voice messages—designed to promote engagement between the agent and the lead, ultimately culminating in a purchase or sale transaction by the agent on behalf of the lead.

In accordance with one aspect of the invention, an engagement score is computed for each lead based on the frequency and quality of contact between the agent and the lead. The engagement score may then be used to prioritize the call list; that is, those leads which are more engaged warrant a higher priority in the call back hierarchy, whereas those leads which are less engaged may be assigned a correspondingly lower call back priority. This allows a busy agent to intelligently allocate resources to increase his or her lead conversion rate. In addition, the engagement score may be used to adjust the content, cadence, and/or sequence of the various messages comprising the funnel to optimize the efficiency of each funnel over time.

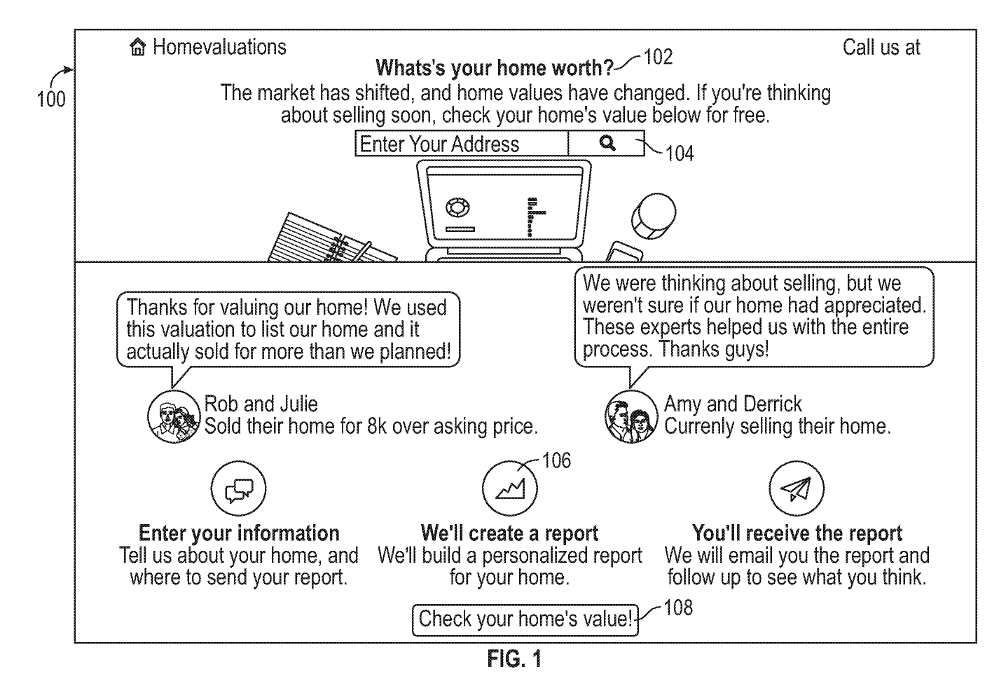

Referring now to FIG. 1, a screen shot 100 of an exemplary seller landing page includes a query 102 designed to motivate a putative seller to begin the process of engaging an agent, such as “What's your home worth?” The seller landing page 100 further includes an information field 104 into which the user may enter a physical address, zip code, name, and/or an email address, and a value proposition field 106 such as an offer to receive a home valuation report (e.g., via email) in exchange for providing sufficient profile information to qualify as a lead. A consummation icon 108 (e.g., “Check your home's value”) invites the user to request a report.

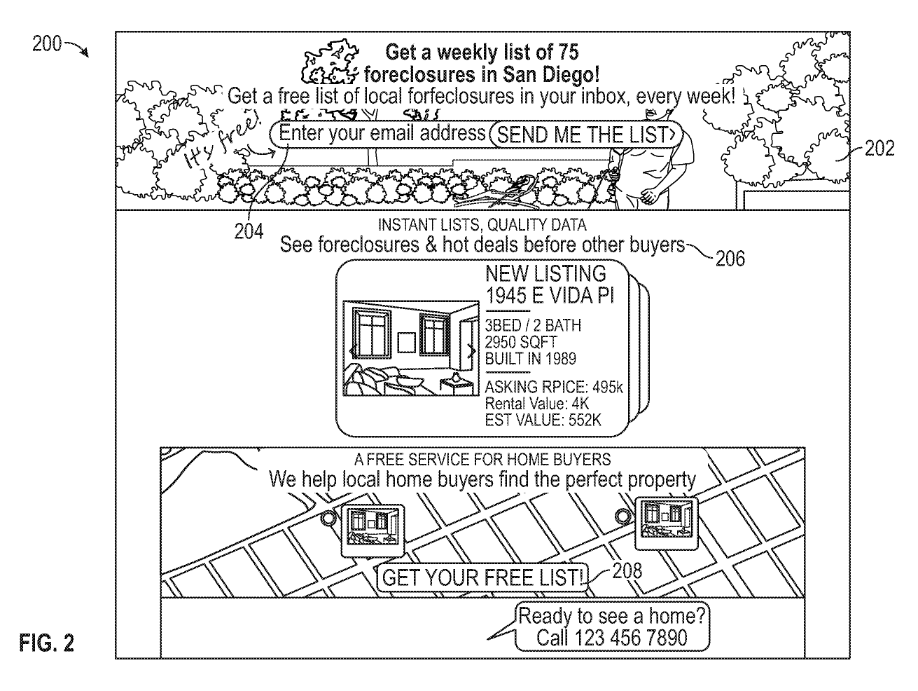

Analogously, FIG. 2 is a screen shot 200 of an exemplary buyer landing page including a buyer query 202 designed to motivate a putative buyer to begin the process of engaging an agent, such as “Get a list of foreclosures in your area.” The buyer landing page 200 further includes an information field 204 into which the user may enter a physical address, zip code, name, and/or an email address, and a value proposition field 206 such as an offer to receive a list of properties (e.g., via email) corresponding to the aforementioned buyer query in exchange for providing sufficient profile information to qualify as a lead. A consummation icon 208 (e.g., “Request your private list”) invites the user to request a listing of relevant properties.

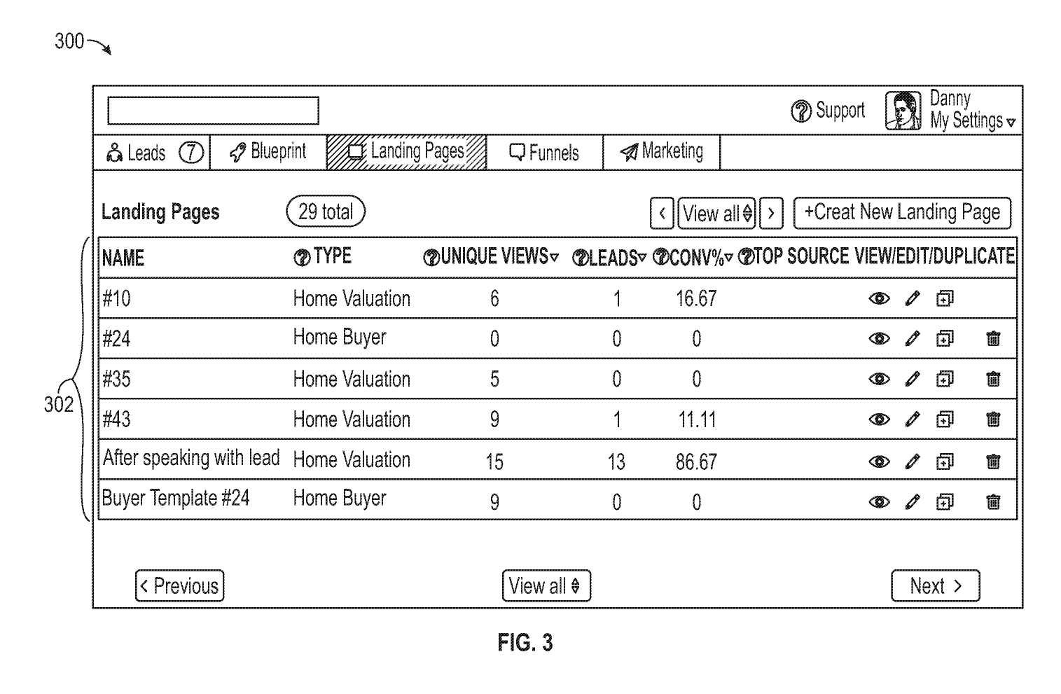

FIG. 3 is a screen shot 300 of an exemplary landing page management tool including a list 302 of landing pages which may be automatically or manually configured. In an embodiment, as certain landing page templates used by other agents are determined to experience higher conversion rates, the system may recommend that lower conversion rate landing pages be replaced by higher conversion rate landing pages.

In various embodiments the system may be configured to assign landing pages to a new agent based on previous performance data associated with the landing pages for existing agents; alternatively, the agent can select one or more landing pages. Based on a landing page's performance (e.g., the observed conversion rate for leads directed to the landing page), the landing pages which experience higher conversion rates are moved up within the landing page template hierarchy. Higher converting pages may then be assigned to new agents, even as new landing pages are introduced into the hierarchy.

In various embodiments, the system may be configured to monitor when a lead opens an email which attaches the requested report, such as a home valuation report requested by a potential seller or a listing of foreclosures requested by a potential buyer. The system may be further configured to monitor when the report itself is opened by the lead. In this way, the system may be configured to send the agent a real time notification indicating that the lead is currently engaged in reviewing the email or the attached report, thereby providing the agent with an opportunity to reach out to the lead when the lead is presumably highly receptive to being contacted by the agent.

By way of non-limiting example, if the report is in the form of a PDF attachment the system can send the alert to the agent at the time the email (or attachment) is opened by the lead. Alternatively, if the report is in the form of a link to a web page, the system can monitor the status of the link and determine when and for how long the report remains open. Alerting the agent to contact the lead while the lead is reviewing the report gives the agent a prime opportunity to engage with the prospect while the prospect is engaged in evaluating the report. In one embodiment, the alert may recommend that the agent send the lead a text or email message, or place a telephone call to the lead calculated to provoke some version of the following dialogue:

Agent (text, email, or live call): “I just thought I'd check in with you to see if you had a chance to review the report I sent you.”

Prospect: “Your timing is perfect; I was just looking at it.”

In an alternative embodiment, the system may be configured to send the agent an alert when new lead is entering profile information into the landing page, allowing the agent to contact the lead immediately upon becoming a new lead.

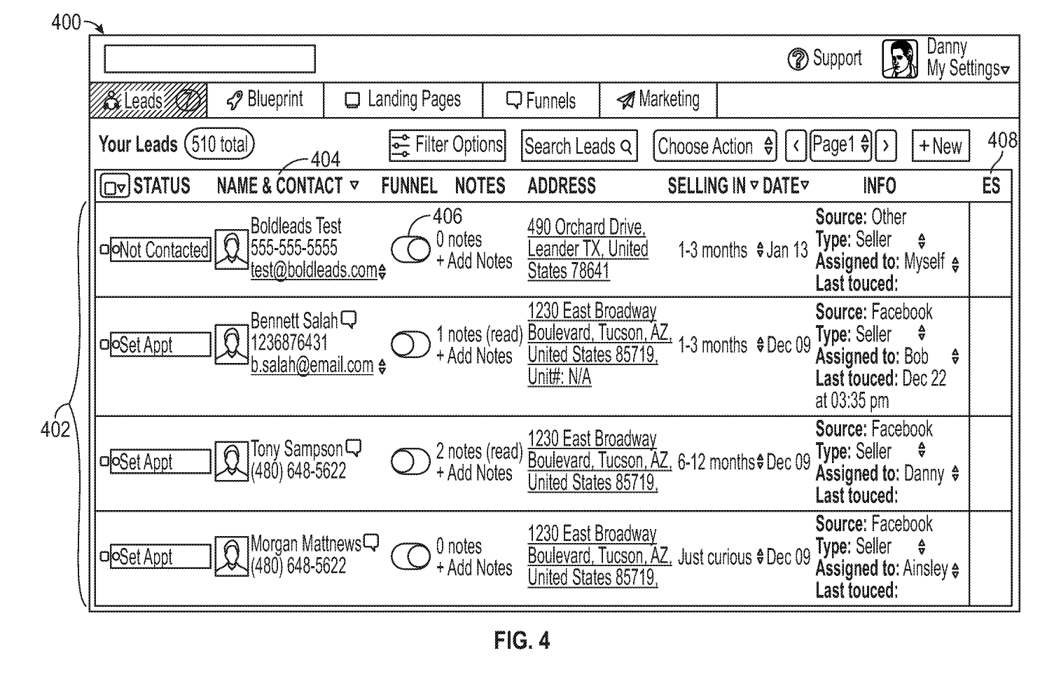

Turning now to FIG. 4, a screen shot 400 of an exemplary call list management tool includes a list of leads 402, each having associated profile information 404, funnel information 406, and an engagement score 408. In the illustrated embodiment, the lead list also functions as a call list, providing the agent with a list of leads prioritized from the highest to the lowest engagement score, as described in greater detail below. For present purposes, the engagement score indicates which leads have been more engaged than others, and thus provides an ordered list allowing the agent to prioritize those leads most likely to ultimately consummate a buyer or seller transaction.

In an embodiment, the lead list 402 allows an agent to send a text directly from the desktop tool (or mobile) application, such that the text message received by the lead bears the agent's mobile phone number so that the lead perceives the text as being more personal. The inbound and outbound texts also appear on the agent's mobile phone; that is, the desktop application simply reproduces the relevant SMS messages (in and outbound) on the screen. In this way, the various metrics (described below) which comprise the engagement scores may be visually tracked by the call list management tool 400. For example, by clicking on the funnel information field 406 for a particular lead, a summary of inbound and outbound text messages, email messages, and telephone calls may be revealed.

As briefly mentioned above, the present invention contemplates a plurality of messaging funnels, each comprising a sequence of themed messages designed to be automatically sent by the system to a lead on behalf of the agent. Each funnel typically corresponds to a particular landing page, and is characterized by a cadence or schedule. For example, a funnel may comprise a first message designed to be sent at a first period of time following the initial lead intake (e.g., five minutes), a second message designed to be sent at a second period of time following the initial lead intake (e.g., one hour minutes), a third message designed to be sent at a third period of time following the initial lead intake (e.g., 24 hours), and so on.

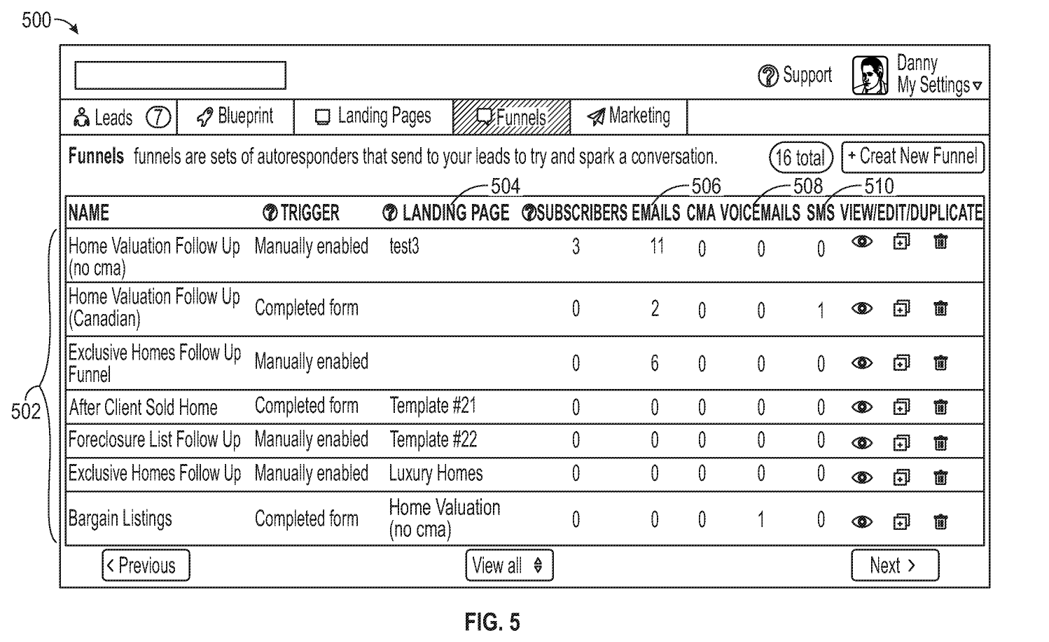

FIG. 5 is a screen shot 500 of an exemplary funnel management tool including a list 502 of funnels for a particular agent, where each funnel may be characterized by an associated landing page 504, the number of email messages 506, number of voice messages 508, and number of text (e.g., SMS) messages 510 comprising the funnel.

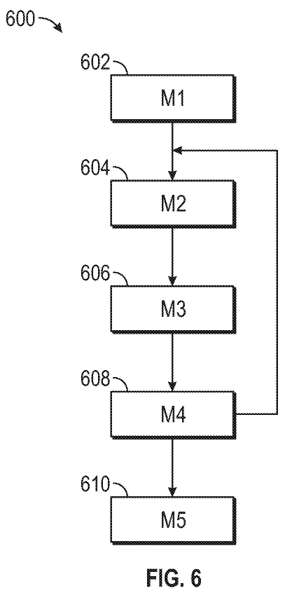

Those emails/texts which are responded to by leads may be tracked and moved up in the funnel hierarchy accordingly. That is, if a funnel has ten touch points (emails and texts), the ones that are responded to by a lead may be earlier in the funnel sequence. With momentary reference to FIG. 6, a schematic block diagram 600 of a dynamically re-configurable messaging funnel includes temporally sequential messages 602-610. If a particular message, say message 608, is responded to by leads more frequently than other messages in the funnel, message 608 may be moved to an earlier point within the funnel template, such as between messages 602 and 604. In this way, the effectiveness of the funnel may be enhanced over time based on empirical data.

In accordance with a further aspect of the invention, the system may be configured to calculate and dynamically update an engagement score for each lead, where the engagement score may be used to determine the order in which leads are placed on a call list. In one embodiment, the engagement score may be calculated based on weighted events such as the opening (or re-opening) of an email by the lead, with the weighting being a function of the content of the email and/or the temporal position (sequence) of the email within a funnel. For example, a straightforward engagement score ES may take the form of:

ES=Ax+By+Cz;

where:

x=total number of emails sent by the agent and opened by the lead;

y=total number of emails sent by the lead to the agent;

z=a call placed by the lead to the agent; and

A, B, and C are weighted coefficients, where events such as a call placed by a lead to an agent carry the highest weight and thereby cause the associated lead to jump to the top of the call list.

In an embodiment, an engagement score may be adjusted (typically increased) when one or more of the following events are detected: an email is opened by the lead; an email is replied to by the lead; the lead visits or re-visits a landing page; the lead reviews a valuation report, listing report, or other report; the lead replies to a text message (replies to texts receive a higher weight than replies to an email, because replies to texts tend to be a better predictor of engagement); and the lead re-visits an “engagement page” (similar a landing page but only tracks behavior but does not capture information, such as a home affordability calculator—these strongly suggest that a buyer is close to buying and have a high weight).

Note that a higher coefficient weight may be applied if certain events (e.g., opening multiple emails) occur within a defined window (e.g., 30 days). Moreover, in some embodiments the entire engagement score may be reset periodically (e.g., every 90 days).

In various embodiments the system may be configured to respond to an engagement score achieving a predetermined threshold value by alerting the agent to contact the associated lead immediately, such as when the lead places a telephone call to the agent. That is, the system tracks all engagement scores for all leads, and presents the agent with a prioritized list of engagement scores from high to low, instructing the agent to follow up with the higher engagement scores first, thereby increasing the conversion rate over time.

In accordance with a further aspect of the invention, the lead management tool 400 may be configured to track interaction between the agent and each lead, for example, recording every touch point such as inbound and outbound emails, texts, automated voice messages and telephone calls actually placed and/or answered. These logs may be used by the desktop application to adjust the engagement score for each lead. The dynamically adjusted engagement scores may then be used to prioritize leads within the call list, as well as to adjust the relative position of individual email, text, and voice within the funnels (e.g., automatically dynamically adjusting the sequencing of messages within each funnel).

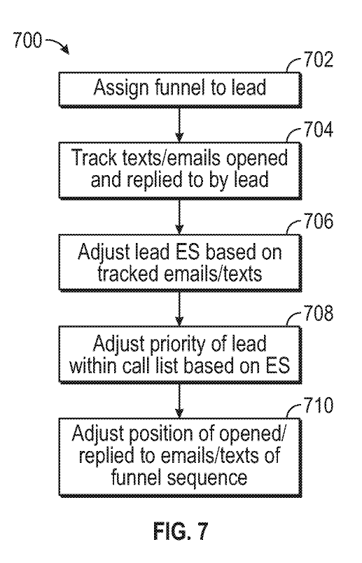

Referring now to FIG. 7, a schematic flow diagram 700 of a method of using engagement scores to update a call lists and messaging funnels includes assigning a funnel to a lead (Task 702); tracking texts/emails opened and/or replied to by the lead (Task 704); adjusting the lead engagement score (ES) based on tracked emails/texts (Task 706); adjusting the priority of the lead within the call list based on the lead's engagement score (Task 708); and adjusting the position of the emails/texts that are opened/replied to by the lead in the funnel template (Task 710).

In accordance with a further aspect of the invention, the system may be configured to simultaneously manage a large number of advertising campaigns for a large number of agents. In particular, the process may be automated by simultaneously monitoring two key metrics associated with each campaign: an ad budget monitor that pulls payment information from a third party payment site; and data of actual ads placed in news feeds. In this way, the two metrics may be compared for each agent, and one or more metrics dynamically adjusted as necessary to maintain the actual number of ads placed in line with the number of ads that have been paid for.

In accordance with yet a further aspect of the invention, the system may be configured to employ a novel technique for mining and harvesting initial buyer leads using landing pages. More particularly, presently known methods of building buyer lead lists involve purchasing MLS lists by zip code from commercial sources (which are expensive to obtain), and capturing the identities of those who view or express an interest in viewing the purchased listings. In one embodiment, the system asks the agents to provide their own MLS lists of foreclosure properties, government owned properties, luxury homes, and the like, and provide a URL for these lists. Ads may then be placed asking potential buyers to request access to the lists, whereupon the identities of those potential buyers may be uploaded to the agent's call list. Stated another way, rather than buying MLS lists from commercial services, the system access the lists already maintained by contracting agents to organically build buyer lists.

A computer system is thus provided for prioritizing prospective leads in a call list for use by a real estate agent. The system includes: a first module configured to manage and display the call list; a second module configured to manage a first messaging funnel associated with a first one of the leads, the first messaging funnel having a first email message x(1) and a first text message y(1); and a third module configured to calculate a first engagement score ES(1)=A1x(1)+B1y(1) for the first lead based on the first funnel, A1 and B1 are weighting coefficients.

In an embodiment, A1=1 when the first email message is opened by the lead, A1=0 when the first email message is not opened by the lead, B1=1 when the first text message is opened by the lead, and B1=0 when the first text message is not opened by the lead.

In an embodiment, A1>1 when the first email message is opened a subsequent time by the lead, and B1>1 when the first text message is opened a subsequent time by the lead.

In an embodiment, the first module is configured to adjust the position of the first lead relative to other leads in the call list based on the relative value of ES(1) to other engagement scores associated with other leads, respectively.

In an embodiment, the second module is configured to adjust the relative positions of the first email message and the first text message within the first funnel based on whether the first email message and the first text message have been opened by the first lead.

In an embodiment, A1≥≥1 when the first email message is replied to by the lead, and B1≥≥1 when the first text message is replied to by the lead.

In an embodiment, the first engagement score ES(1)=A1x(1)+B1y(1)+C1z(1) where z(1) corresponds to the first lead contacting the agent, and C1>A1 and C1>B1.

In an embodiment, the first engagement score further contemplates at least one of the following events: the lead visits a landing page; the lead or re-visits a landing page; the lead visits an engagement page; and the lead re-visits an engagement page.

In an embodiment, the first engagement score is periodically reset to a baseline value.

A method is provided for managing leads for a real estate agent. The method includes: sending, in response to a request for a report, an email message to a lead including an attached link to a web page containing the report; monitoring the status of the link to determine when the web page is opened by the lead; and sending an alert to the agent in real time while the web page is opened advising the agent to contact the lead.

In an embodiment, the method further includes: determining whether the agent contacts the lead while the web page is opened and, if not, sending an elevated alert to the agent's supervisor advising the supervisor to contact the lead while the webpage is opened.

In an embodiment, the method further includes: sending a second alert to the agent in real time when the web page is re-opened.

A method is also provided for managing a call list of leads for a real estate agent. The method includes: maintaining respective logs of text and email messages for a plurality of leads; adjusting a respective engagement score for each lead based on that lead's email and text log; and adjusting the relative position of each lead in the call list based on the relative value of each lead's engagement score.

In an embodiment, the method further includes: assigning a respective funnel to each lead, where each funnel comprises a sequence of messages.

In an embodiment, the method further includes: adjusting the position of each message within each funnel based on each associated lead's email and text log.

The foregoing description is considered as illustrative only of the principles of the invention. Further, since numerous modifications and changes will readily occur to those skilled in the art, it is not desired to limit the invention to the exact construction and process shown and described above. Accordingly, all suitable modifications and equivalents may be considered as failing within the scope of the invention.

We claim:

1. A computer system for prioritizing prospective leads in a call list for use by a real estate agent, the system comprising:
a first module configured to manage and display the call list;
a second module configured to manage a first messaging funnel associated with a first one of the leads, the first messaging funnel having a first email message x(1) and a first text message y(1); and
a third module configured to calculate a first engagement score ES(1)=A₁x(1)+B₁y(1) for the first lead based on the first funnel, A₁ and B₁ are weighting coefficients.

2. The system of claim 1, where A₁=1 when the first email message is opened by the lead, A₁=0 when the first email message is not opened by the lead, B₁=1 when the first text message is opened by the lead, and B₁=0 when the first text message is not opened by the lead.

3. The system of claim 1, wherein A₁>1 when the first email message is opened a subsequent time by the lead, and B₁>1 when the first text message is opened a subsequent time by the lead.

4. The system of claim 1, wherein the first module is configured to adjust the position of the first lead relative to other leads in the call list based on the relative value of ES(1) to other engagement scores associated with other leads, respectively.

5. The system of claim 1, wherein the second module is configured to adjust the relative positions of the first email message and the first text message within the first funnel based on whether the first email message and the first text message have been opened by the first lead.

6. The system of claim 1, wherein A₁≥≥1 when the first email message is replied to by the lead, and B₁≥≥1 when the first text message is replied to by the lead.

7. The system of claim 1, wherein the first engagement score ES(1)=A₁x(1)+B₁y(1)+C₁z(1) where z(1) corresponds to the first lead contacting the agent, and C₁>A₁ and C₁>B₁.

8. The system of claim 1, wherein the first engagement score further contemplates at least one of the following events: the lead visits a landing page; the lead or re-visits a landing page; the lead visits an engagement page; and the lead re-visits an engagement page.

9. The system of claim 1, wherein the first engagement score is periodically reset to a baseline value.

10. A method of managing leads for a real estate agent, comprising the steps of:
sending, in response to a request for a report, an email message to a lead including an attached link to a web page containing the report;
monitoring the status of the link to determine when the web page is opened by the lead; and
sending an alert to the agent in real time while the web page is opened advising the agent to contact the lead.

11. The method of claim 10, further comprising:
determining whether the agent contacts the lead while the web page is opened and, if not, sending an elevated alert to the agent's supervisor advising the supervisor to contact the lead while the webpage is opened.

12. The method of claim 10, further comprising:
sending a second alert to the agent in real time when the web page is re-opened.

13. A method of managing a call list of leads for a real estate agent, comprising:
maintaining respective logs of text and email messages for a plurality of leads;
adjusting a respective engagement score for each lead based on that lead's email and text log; and
adjusting the relative position of each lead in the call list based on the relative value of each lead's engagement score.

14. The method of claim 13, further comprising:
assigning a respective funnel to each lead, where each funnel comprises a sequence of messages.

15. The method of claim 14, further comprising:
adjusting the position of each message within each funnel based on each associated lead's email and text log.
